(19) United States
(12) Patent Application Publication
(10) Pub. No.: US 2010/0036530 A1
(43) Pub. Date: Feb. 11, 2010

(54) AIR CONDITIONING SYSTEMS AND METHODS HAVING FREE-COOLING PUMP STARTING SEQUENCES

(75) Inventors: Julien Chessel, Villieu Loyes Mollon (FR); Pierre Delpech, Fleurier-sur-Saone (FR); Jean-Philippe Goux, Toussieu (FR)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: CARRIER CORPORATION, Farmington, CT (US)

(21) Appl. No.: 12/520,828

(22) PCT Filed: Dec. 22, 2006
(86) PCT No.: PCT/US2006/049121

§ 371 Date: Jun. 22, 2009

(51) Int. Cl. G05B 15/00; F25B 1/00

(52) U.S. Cl. 700/275; 62/498

(57) ABSTRACT

An air conditioning system having a cooling mode and a free-cooling mode is provided. The system includes a refrigeration circuit, two pressure sensors, a controller, and a pump starting sequence resident on the controller. The refrigeration circuit includes a compressor and a pump. The first pressure sensor is at an inlet of the pump, while the second pressure sensor is at an outlet of the pump. The controller selectively operates in the cooling mode by circulating and compressing a refrigerant through the refrigeration circuit via the compressor or operates in the free-cooling mode by circulating the refrigerant through the refrigeration circuit via the pump. The pump starting sequence cycles the pump between an on state and an off state based at least upon a differential pressure determined by the controller from pressures detected by the pressure sensors.

### BACKGROUND OF THE INVENTION

1. Field of the Invention

The present disclosure is related to air conditioning systems. More particularly, the present disclosure is related to methods and systems for controlling air conditioning systems having a free-cooling mode and a cooling mode.

2. Description of Related Art

During the typical operation of air conditioning systems, the system is run in a cooling mode wherein energy is expended by operating a compressor. The compressor to compresses and circulates a refrigerant to chill or condition a working fluid, such as air or other secondary loop fluid (e.g., chilled water or glycol), in a known manner. The conditioned working fluid can then be used in a refrigerator, a freezer, a building, an automobile, and other spaces with climate controlled environment.

However, when the outside ambient temperature is low, there exists the possibility that the outside ambient air itself may be utilized to provide cooling to the working fluid without engaging the compressor. When the outside ambient air is used by an air conditioning system to condition the working fluid, the system is referred to as operating in a free-cooling mode.

As noted above, traditionally, even when the ambient outside air temperature is low, the air conditioning system is run in the cooling mode. Running in cooling mode under such conditions provides a low efficiency means of conditioning the working fluid. In contrast, running the air conditioning system under such conditions in a free-cooling mode is more efficient. In the free-cooling mode, one or more ventilated heat exchangers and pumps are activated so that the refrigerant is circulated by the pumps and is cooled by the outside ambient air. In this manner, the refrigerant, cooled by the outside ambient air, can be used to cool the working fluid without the need for the low efficiency compressor.

Accordingly, it has been determined by the present disclosure that there is a need for methods and systems that improve the efficiency of air conditioning systems having a free cooling mode.

### BRIEF SUMMARY OF THE INVENTION

Air conditioning systems and methods of controlling are provided that include a pump starting sequence for cycling a free-cooling refrigerant pump between an on state and an off state based at least upon a differential pressure across the pump.

An air conditioning system having a cooling mode and a free-cooling mode is provided. The system includes a refrigeration circuit, two pressure sensors, a controller, and a pump starting sequence resident on the controller. The refrigeration circuit includes a compressor and a pump. The first pressure sensor is at an inlet of the pump, while the second pressure sensor is at an outlet of the pump. The controller selectively operates in the cooling mode by circulating and compressing a refrigerant through the refrigeration circuit via the compressor or operates in the free-cooling mode by circulating the refrigerant through the refrigeration circuit via the pump. The pump starting sequence cycles the pump between an on state and an off state based at least upon a differential pressure determined by the controller from pressures detected by the pressure sensors.

A method of controlling an air conditioning system having a cooling mode and a free-cooling mode is also provided. The method includes switching the air conditioning system to the free-cooling mode; initiating a pump start-up sequence to cycle a refrigerant pump between an on state and an off state; and maintaining the air conditioning system in the free-cooling mode after completion of the pump start-up sequence.

The above-described and other features and advantages of the present disclosure will be appreciated and understood by those skilled in the art from the following detailed description, drawings, and appended claims.

### BRIEF DESCRIPTION OF THE SEVERAL VIEWS OF THE DRAWINGS

FIG. 1 is an exemplary embodiment of an air conditioning system in cooling mode according to the present disclosure;

FIG. 2 is an exemplary embodiment of an air conditioning system in free-cooling mode according to the present disclosure;

FIG. 3 illustrates an exemplary embodiment of a method of operating the air conditioning system of FIGS. 1 and 2 according to the present disclosure; and

FIG. 4 is a graph illustrating the pump starting sequence of FIG. 3.

### DETAILED DESCRIPTION OF THE INVENTION

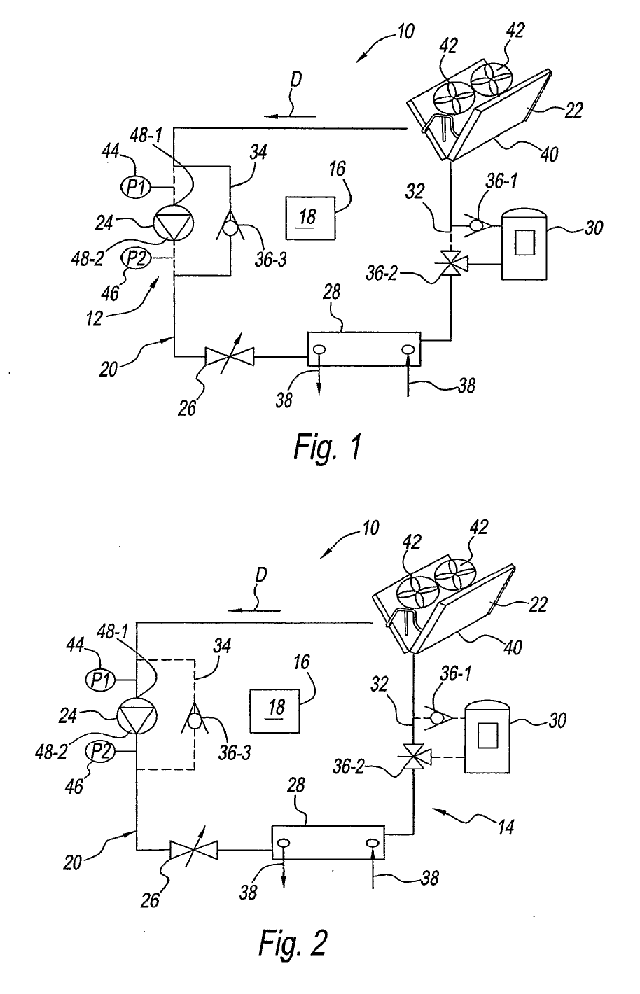

Referring now to the drawings and in particular to FIGS. 1 and 2, an exemplary embodiment of an air conditioning system (“system”) according to the present disclosure, generally referred to by reference numeral 10, is shown. System 10 is configured to operate in a cooling mode 12 (FIG. 1) and a free-cooling mode 14 (FIG. 2).

System 10 includes a controller 16 for selectively switching between cooling and free-cooling modes 12, 14. Advantageously, controller 16 includes a pump starting sequence 18 resident thereon that monitors pressure in system 10 during the initiation of free-cooling mode 14 to mitigate instances of pump cavitation. In this manner, system 10 improves pump reliability during the initiation of free-cooling mode 14 as compared to prior art systems.

System 10 also includes a refrigeration circuit 20 that includes a condenser 22, a pump 24, an expansion device 26, an evaporator 28, and a compressor 30. Controller 16 is configured to selectively control either compressor 30 (when in cooling mode 12) or pump 24 (when in free-cooling mode 14) to circulate a refrigerant through system 10 in a flow direction (D). Thus, system 10, when cooling mode 12, controls compressor 30 to compress and circulate the refrigerant in flow direction 30. However, system 10, when in free-cooling mode 14, controls pump 24 to circulate the refrigerant in flow direction 30. As such, the free-cooling mode 14 uses less energy then cooling mode 12 since the free-cooling mode does not require the energy expended by compressor 30.

System 10 includes a compressor by-pass loop 32 and a pump by-pass loop 34. Compressor by-pass loop 32 is controlled by a first check valve 36-1 and a three-way valve 36-2, which is controlled by controller 16. Pump by-pass loop 34 includes a second check valve 36-3. In this manner, controller 16 can selectively position valves 36-2 to selectively open and close compressor by-pass loop 32 as desired.

In cooling mode 12, controller 16 controls valve 36-3 so that compressor by-pass loop 32 is closed and pump by-pass loop 34 is naturally opened by the flow of refrigerant through second check valve 36-3. In this manner, system 10 is configured to allow compressor 30 to compress and circulate refrigerant in the flow direction 30 by flowing through pump by-pass loop 34.

In contrast, controller 16, when in free-cooling mode 14, controls valve 36-2 so that compressor by-pass loop 32 is open. In this manner, system 10 is configured to allow pump 24 to circulate refrigerant in the flow direction 30 by flowing through compressor by-pass loop 32. As soon as pump 24 is started, pressure induced in circuit 20 by the pump closes check valve 36-3, which closes by pass loop 34, as well as closing check valve 36-2 preventing back flow of refrigerant into compressor 30.

Accordingly, system 10 can condition (i.e., cool and/or dehumidify) a working fluid 38 in heat-exchange communication with evaporator 28 in both cooling and free cooling modes 12, 14. Working fluid 38 can be ambient indoor air or a secondary loop fluid such as, but not limited to chilled water or glycol.

In cooling mode 12, system 10 operates as a standard vapor-compression air conditioning system known in the art where the compression and expansion of refrigerant via expansion device 26 are used to condition working fluid 38. Expansion device 26 can be any known expansion device such as, but not limited to, fixed expansion device (e.g., an orifice) or a controllable expansion device (e.g., a thermal expansion valve). In the example where expansion device 26 is a controllable expansion device, the expansion device is preferably controlled by controller 16.

In free-cooling mode 14, system 10 uses takes advantage of the heat removing capacity of outdoor ambient air 40, which is in heat exchange relationship with condenser 22 via one or more fans 42, to condition working fluid 38.

It has been determined by the present disclosure that refrigerant leaving condenser 22 can be in one of several different phases, namely a gas phase, a liquid-gas phase, or a liquid phase. When controller 16 switches system 10 to free-cooling mode 14, pump 24 is supplied with refrigerant in the different phases until the system reaches a state of equilibrium in full circuit. The time to reach the state of equilibrium in full circuit depends on various aspects of system 10. In many systems 10, the state of equilibrium can be reached in from between 1 to 3 minutes after controller 16 initiates free-cooling mode 14.

After controller 16 initiates free-cooling mode 14 and during the time it takes for system 10 to reach equilibrium, pump 24 is supplied with refrigerant in the different phases. Unfortunately, when pump 24 is supplied with refrigerant the gas or liquid-gas phases, the pump does not operate as desired. Moreover, the gas phase and/or liquid-gas phase refrigerant can cause pump 24 to cavitate, which can damage the pump and/or the pump motor (not shown).

Turning off pump 24 would stop the potential damage from such cavitation, but also would result in delaying the ability for system 10 to easily switch from cooling mode 12 to free-cooling mode 14. Advantageously, controller 16 includes pump starting sequence 18 that selectively cycles pump 24 between an “on” state and an “off” state during time period after switching into free-cooling mode 14 from cooling mode 12. Thus, controller 16 operates pump 24, during pump starting sequence 18, in such a manner to creating a liquid suction and venting gas of pump piping.

System 10 includes a first pressure sensor 44 and a second pressure sensor 46 in electrical communication with controller 16. First pressure sensor 44 is positioned at an entrance 48-1 of pump 24, while second pressure sensor 46 is positioned at an exit 48-2 of the pump. Controller 16 uses the pressures measured by first and second sensors 44, 46 to determine a pump pressure difference in real-time. Moreover, controller 16 cycles pump 24 between the on and off states based upon the pump pressure differential during pump starting sequence 18.

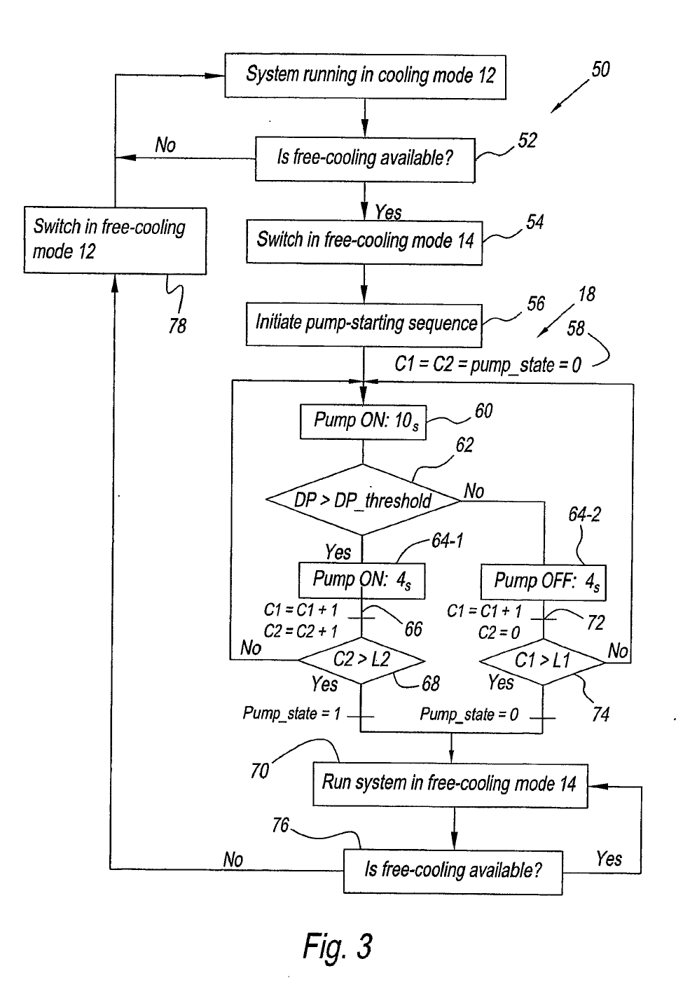

The operation of pump starting sequence 18 is described in more detail with reference to FIG. 3. FIG. 3 illustrates an exemplary embodiment of a method 50 of controlling system 10 having pump starting sequence 18, as well as an exemplary embodiment of the pump starting sequence according to the present disclosure.

Method 50, when system 10 is operating in cooling mode 12, includes a first free cooling determination step 52. During first free cooling determination step 52, method 50 determines whether the temperature of ambient air 40 is sufficient for system 10 to switch to free-cooling mode 14. If free cooling is available, method 50 switches system 10 into free cooling mode 14 at a free-cooling switching step 54. If free cooling is not available, method 50 continues to operate system 10 in cooling mode 12.

It should be recognized that method 50 is described herein by way of example in use while system 10 is operating in cooling mode 12. Of course, it is contemplated by the present disclosure for method 50 to find equal use when system 10 is stopped such that pump starting sequence 18 avoids pump cavitation during start-up of system 10 into free-cooling mode 14 from a stopped state.

After free-cooling switching step 54, method 50 includes a pump initiation step 56, where method 50 initiates pump starting sequence 18. Pump starting sequence 18 includes a counter reset step 58. Counter reset step 58 sets a first counter C1, a second counter C2, and a pump_state to zero (0). The pump_state is a binary state, where in state zero (0) pump 24 is defusing and in state one (1) the pump is primed.

Pump starting sequence 18 also includes a first pump cycling step 60. First pump cycling step 60 switches pump 24 to the “on” state for a first predetermined time period. In the illustrated embodiment, the first predetermined time period is set at ten (10) seconds. However, it is contemplated for the first predetermined time period to be set to any longer or shorter time period, as necessary.

When pump 24 is cycled to the “on” state by first pump cycling step 60, controller 16 continuously compares the pump differential pressure (DP) to a predetermined differential pressure threshold (DP_threshold) during a comparison step 62. As used herein, the pump differential pressure (DP) is the difference of the pressures measured by first and second sensors 44, 46.

If DP is larger than DP_threshold at first comparison step 62, then sequence 18 leaves pump 24 in the “on” state for a second predetermined time period 64-1. In the illustrated embodiment, the second predetermined time period 64-1 is set at four (4) seconds. However, it is contemplated for the second predetermined time period to be set to any longer or shorter time period, as necessary.

After the second predetermined time period 64-1, sequence 18 includes a first counter incrementing step 66. First counter incrementing step 66 increases each of the first counter C1 and the second counter C2 by one (1) unit.

If second counter C2 is greater than second load constant (L2) at a second comparison step 68, then sequence 18 sets the pump state to one (1) and exits sequence 18 to a run in free-cooling mode step 70 such that system 10 operates in free-cooling mode 14.

The second load constant L2 is based on a size of system 10. Further, the second load constant L2 is less than a first load constant (L1), which is also based on a size of system 10. The first and second load constants L1 and L2 are based on various variables of pump 24.

If second counter C2 is less than or equal to second load constant (L2) at second comparison step 68, then sequence 18 returns to first pump cycling step 60 and repeats the sequence.

However, if DP is equal to or less than DP_threshold at first comparison step 62, then sequence 18 switches pump 24 to the “off” state for the second predetermined time period 64-2. In the illustrated embodiment, the second predetermined time period 64-2 is also set at four (4) seconds.

It should be recognized that second predetermined time periods 64-1 and 64-2 are set at four (4) seconds by way of example only. Of course, it is contemplated by the present disclosure for second predetermined time periods 64-1 and 64-2 to be more or less than four (4) seconds. Additionally, the second predetermined time period for both the “on” state (i.e., 64-1) and the “off” state (i.e., 64-2) of pump 24 are illustrated by way of example as equal to one another. However, it is also contemplated for the second predetermined time periods 64-1 and 64-2 to be the same or different from one another.

After the second predetermined time period 64-2, sequence 18 includes a second counter incrementing step 72. Second counter incrementing step 72 increases the first counter C1 by one (1) unit but sets the second counter C2 to zero (0).

If first counter C1 is greater than the first load constant (L1) at a third comparison step 74, then sequence 18 sets the pump state to zero (0) and exits sequence 18 to run in free-cooling mode step 70 such that system 10 operates in free-cooling mode 14.

If first counter C1 is less than or equal to the first load constant (L1) at third comparison step 74, then sequence 18 returns to first pump cycling step 60 and repeats the sequence.

In this manner, sequence 18 is configured to cycle pump 24 on and off until refrigerant in system 10 reaches a state of equilibrium. In the state of equilibrium, the refrigerant in system 10 is predominantly presented to pump 24 in a liquid phase.

It should also be noted that, during pump starting sequence 18, method 50 operates system 10 so that controller 16 turns off compressor 30 and opens compressor by-pass 32. Once pump 24 has started, the pressure of induced in circuit 20 by the pump automatically closes check valve 36-3 at pump by-pass 34 and check valve 36-1 at compressor 30.

Upon completion of pump starting sequence 18, method 50 operates system 10 in free-cooling mode 14 at free-cooling step 70, where pump 24 is maintained in the “on” state.

While operating in free-cooling mode 14, method 50 may, in some embodiments, includes a second free cooling determination step 76. During second free cooling determination step 76, method 50 determines whether the temperature of ambient air 40 is sufficient for system 10 to remain in free-cooling mode 14. If free cooling is available, method 50 maintains system 10 in free cooling mode 14. If free cooling is not available, method 50 switches system 10 into cooling mode 12 at a cooling switching step 78.

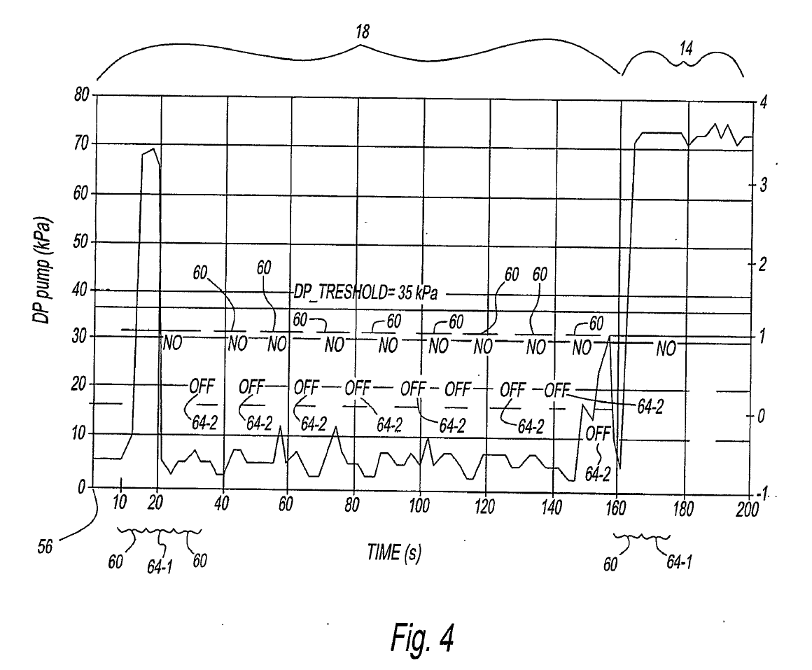

FIG. 4 is a graph illustrating the pressure differential across pump 24 before, during, and after pump starting sequence 18. In the illustrated embodiment, the predetermined pressure differential threshold (PD_threshold) was set at 35 kilopascals (kPa), the first load constant (L1) was set at 20, and the second load constant (L2) was set at 4. However, it should be recognized that the present disclosure is not limited by this exemplary embodiment of predetermined pressure differential threshold, first load constant (L1), or second load constant (L2).

Beginning at time zero (0), system 10 has determined that sufficient free-cooling capacity is available at step 52 and has switched in to free-cooling mode 14 at step 54, thus FIG. 4 begins at step 56 of method 50.

As shown sequence 18 switches pump 24 to the “on” state at first pump cycling step 60 for about ten (10) seconds. Then, sequence 18 proceeds to cycle pump 24 between the “on” and “off” states for the first and second predetermined time period 60, 64-1, 64-2 as discussed above. Once sequence 18 determines pump 24 meets the conditions, method 50 moves to run in free-cooling mode step 70 and operates system 10 in free-cooling mode 14.

Accordingly, system 10 and method 50 of the present disclosure having pump starting sequence 18 can be used to easily switch from cooling mode 12 to free-cooling mode 14 while mitigating the operation of pump 24 during the time when the refrigerant is in a gaseous phase and/or a gas-liquid mixture phase. As such, system 10 and method 50 of the present disclosure prevent damage to pump 24 due to cavitation of the pump

It should also be noted that the terms “first”, “second”, “third”, “upper”, “lower”, and the like may be used herein to modify various elements. These modifiers do not imply a spatial, sequential, or hierarchical order to the modified elements unless specifically stated.

While the present disclosure has been described with reference to one or more exemplary embodiments, it will be understood by those skilled in the art that various changes may be made and equivalents may be substituted for elements thereof without departing from the scope of the present disclosure. In addition, many modifications may be made to adapt a particular situation or material to the teachings of the disclosure without departing from the scope thereof. Therefore, it is intended that the present disclosure not be limited to the particular embodiment(s) disclosed as the best mode contemplated, but that the disclosure will include all embodiments falling within the scope of the appended claims.

What is claimed is:

1. An air conditioning system having a cooling mode and a free-cooling mode, comprising:
a refrigeration circuit have a compressor and a pump;
a first pressure sensor at an inlet of said pump;
a second pressure sensor at an outlet of said pump;
a controller for selectively operating in the cooling mode by circulating and compressing a refrigerant through said refrigeration circuit via said compressor or operating in the free-cooling mode by circulating said refrigerant through said refrigeration circuit via said pump; and
a pump starting sequence resident on said controller, said pump starting sequence cycling said pump between an on state and an off state based at least upon a differential pressure determined by said controller from pressures detected by said first and second pressure sensors.

2. The air conditioning system as in claim 1, wherein said pump starting sequence cycles said pump between said on and off states when said controller switches to the free-cooling mode from a stopped state of the air conditioning system.

3. The air conditioning system as in claim 1, wherein said pump starting sequence cycles said pump between said on and off states when said controller switches to the free-cooling mode from the cooling mode.

4. The air conditioning system as in claim 1, wherein said pump starting sequence cycles said pump between said on and off states based at least upon a comparison of said differential pressure to a predetermined pressure differential threshold.

5. The air conditioning system as in claim 1, wherein said refrigeration circuit further comprises an evaporator in heat exchange communication with said refrigerant and a working fluid.

6. The air conditioning system as in claim 5, wherein said working fluid comprises ambient indoor air

7. The air conditioning system as in claim 5, wherein said working fluid comprises a secondary loop fluid.

8. The air conditioning system as in claim 1, wherein said refrigeration circuit further comprises an expansion device.

9. The air conditioning system as in claim 8, wherein said expansion device is a fixed expansion device.

10. The air conditioning system as in claim 8, wherein said expansion device is a controllable expansion device.

11. The air conditioning system as in claim 10, wherein said controllable expansion device is controlled by said controller.

12. A method of controlling an air conditioning system having a cooling mode and a free-cooling mode, the method comprising the steps of:
switching the air conditioning system to the free-cooling mode;
initiating a pump start-up sequence to cycle a refrigerant pump between an on state and an off state; and
maintaining the air conditioning system in the free-cooling mode after completion of said pump start-up sequence.

13. The method as in claim 12, wherein initiating said pump start-up sequence comprises:
cycling said refrigerant pump between said on and an off states based upon a comparison of a pressure differential across said pump to a threshold pressure.

14. The method as in claim 13, wherein said cycling step comprises:
cycling said refrigerant pump to said on state for a first predetermined time;
maintaining said refrigerant pump in said on state for a second predetermined time if said pressure differential is greater than said threshold pressure; and
cycling said refrigerant pump to said off state for said second predetermined time if said pressure differential is less than said threshold pressure.

15. The method as in claim 14, wherein said second predetermined time if said pressure differential is greater than said threshold pressure is equal to said second predetermined time if said pressure differential is less than said threshold pressure.

16. The method as in claim 14, wherein said initiating said pump start-up sequence comprises setting a first counter C1, a second counter C2, and a pump state to a zero state.

17. The method as in claim 16, wherein said pump state is a binary state comprising said zero state zero where said pump is defusing and an one state where said pump is primed.

18. The method as in claim 16, wherein, if said pressure differential is greater than said threshold pressure, said cycling step further comprises:
indexing said first counter C1 one unit;
indexing said second counter C2 one unit;
comparing said second counter C2 to a second load constant L2;
repeating said cycling step if said second counter C2 is less than said second load constant L2; and
completing said pump start-up sequence if said second counter C2 is greater than said second load constant L2 so that the air conditioning system is maintained in the free-cooling mode.

19. The method as in claim 16, wherein, if said pressure differential is less than said threshold pressure, said cycling step further comprises:
indexing said first counter C1 one unit;
setting said second counter C2 to zero;
comparing said first counter C1 to a first load constant L1;
repeating said cycling step if said first counter C1 is less than said first load constant L1; and
completing said pump start-up sequence if said first counter C1 is greater than said first load constant L1 so that the air conditioning system is maintained in the free-cooling mode.

20. The method as in claim 12, wherein said switching the air conditioning system to the free-cooling mode step comprises switching to the free-cooling mode from the cooling mode or from a stopped state of the air conditioning system.
